(19) United States
(12) Patent Application Publication
(10) Pub. No.: US 2004/0049469 A1
(43) Pub. Date: Mar. 11, 2004

(54) Ranking system and ranking mehod

(76) Inventors: Nozomu Saruhashi, Osaka (JP); Takashi Tsuzumidani, Osaka (JP)

Correspondence Address: FROMMER LAWRENCE & HAUG LLP, 745 Fifth Avenue, New York, NY, 10151, US

(21) Appl. No.: 10/192,031

(22) Filed: Jul. 10, 2002

(30) Foreign Application Priority Data
Jul. 13, 2001 (JP) 2001-214398

(51) Int. Cl. G06F 15/16; H04K 1/00

(52) U.S. Cl. 705/79; 709/217

(57) ABSTRACT

OBJECT The object of the present invention is to provide a “ranking system” by noticing a relation between said “foreign language conversation communication ability” and “sports ability” and aims for an improvement of a communication ability in a foreign language.

SOLVING MEANS

The ranking system comprises a means for entering a sports field or a record or ranking thereof, a means for calculating a sport score from said record or ranking, a means for choosing a language, a means for entering the foreign language conversation communication ability, a means for calculating a language score from said foreign language conversation communication ability, a means for processing a ranking by comparing via network said sport score and said language score with data recorded and accumulated in a network server, and a means for displaying said ranking.

[symbol] augmented by an improvement of “text comprehensive power”.

In recent, “training abroad” is prosperously happened, through which it is said that it is possible to gain experiences in actual climate conditions such as the temperature or atmospheric pressure in a foreign country.

From the foregoing, in order for athletes participating in international games as well as all peoples who like sports to well adapt themselves to life abroad and to be capable of communicating with athletes of other country, they strive for an improvement of “foreign language conversation communication ability” such as English, etc. by using their own methods.

### PROBLEMS TO BE SOLVED IN THE INVENTION

As to the estimation of “sports ability” as described above, “ranking”• “record” produced in an elimination match held by a sports organization or a large scale game are estimated, but the results produced in small-scale games such as local sports games are usually excluded and are not estimated. In actuality, therefore, even a good athlete of real ability cannot be appeared in “a stage for selection”, and then may terminate his athletic life without coming to a stage for selection.

On the other hand, a selector cannot select a good athlete because such good athlete cannot come to “a stage for selection”.

Under such circumstances, conventionally, investigators or scouts are sent to the whole country to perform an information collection or the like, which causes another problems that much more cost and much more time are needed.

Meanwhile, as to “foreign language conversation communication ability”, such ability can generate some advantages that it is possible to composedly cope with life abroad and to prevent athlete from bad mental effects owing to the difficulty of communication. Specifically, if an athlete has acquired “conversation power”, he can perform a dispute with a judge or a communication with other athletes in a harmonious manner, and as result, he can play with confidence in a game and can show his “sports ability” at a maximum.

In this way, since “foreign language conversation communication ability” exerts influence on “sports ability” of an athlete, it can be thought that it is an important consideration in selecting and appointing an excellent athlete.

In case where one notices a relation between said “foreign language conversation communication ability” and “sports ability” and aims for an improvement of a communication ability in a foreign language, it is desired to develop an effective acquisition means because words used in each kind of sports, that is, technical terms are different.

If there is a good acquisition means, athletes and people who like sports will endeavor after learning a language, the desire to go “training abroad” or to assume a communication with people of other country will be increased, and it is possible to plan an internationalization of sports and further a progress of internationalization consciousness of a people.

The present invention is to provide a “ranking system” which considers the above described relation between “foreign language conversation communication ability” and “sports ability”.

### MEANS TO SOLVE THE PROBLEMS

Problems to be solved in the present invention are described as above, and means to solve the problems are described below.

As claimed in claim 1, a ranking system comprises a means for entering a sports field or a record or ranking thereof, a means for calculating a sport score from said record or ranking, a means for choosing a language, a means for entering the foreign language conversation communication ability, a means for calculating a language score from said foreign language conversation communication ability, a means for processing a ranking by comparing via network said sport score and said language score with data recorded and accumulated in a network server, and a means for displaying said ranking.

As claimed in claim 2, said criteria for estimating the foreign language conversation communication ability comprise the lesson frequency and the conversation lesson time in language education facilities or network conversation lessons.

As claimed in claim 3, said criteria for estimating the foreign language conversation communication ability comprise an estimated level which is acknowledged by language education facilities or during network conversation lessons.

As claimed in claim 4, said ranking system, as to the resulted language score, has a means for proposing information to improve a language score.

As claimed in claim 5, the information offered by said means for proposing information to improve a language score comprises a list of the words used in the sports field in which the entrant participates, an example sentence using the word(s), and a voice information reading aloud the above example sentence.

As claimed in claim 6, the information offered by said means for proposing information to improve a language score comprises an introduction of language education facilities and network conversation lessons.

As claimed in claim 7, the contents of said ranking are automatically delivered to the computers of a selector and an entrant by means of an information delivery means installed in a network server.

As claimed in claim 8, the result of said ranking is employed as the criteria for selecting international sportsmen who are excellent in the sports ability and the foreign language conversation communication ability.

As claimed in claim 4, the result of said ranking is employed as the criteria for selecting international instructors who are excellent in a special technology or skill and the foreign language conversation communication ability.

As claimed in claim 4, said ranking is prepared by adding the above sport score and language score to the existing official ranking, a new ranking is prepared from the resulted ranking, and the new ranking is employed as the criteria for selecting a sportsman who has both of the sports ability and the foreign language conversation communication ability.

As claimed in claim 11, a method of ranking sportsmen or instructors comprises a step for entering a sports field or a record or ranking thereof, a step for calculating a sport score from said record or ranking, a step for choosing a language, a step for entering the foreign language conversation communication ability, a step for calculating a language score from said foreign language conversation communication ability, a step for processing a ranking by comparing via network said sport score and said language score with data recorded and accumulated in a network server, and a step for displaying said ranking.

### EMBODIMENTS OF THE INVENTION

From now, embodiments of the present invention are illustrated with reference to the drawings.

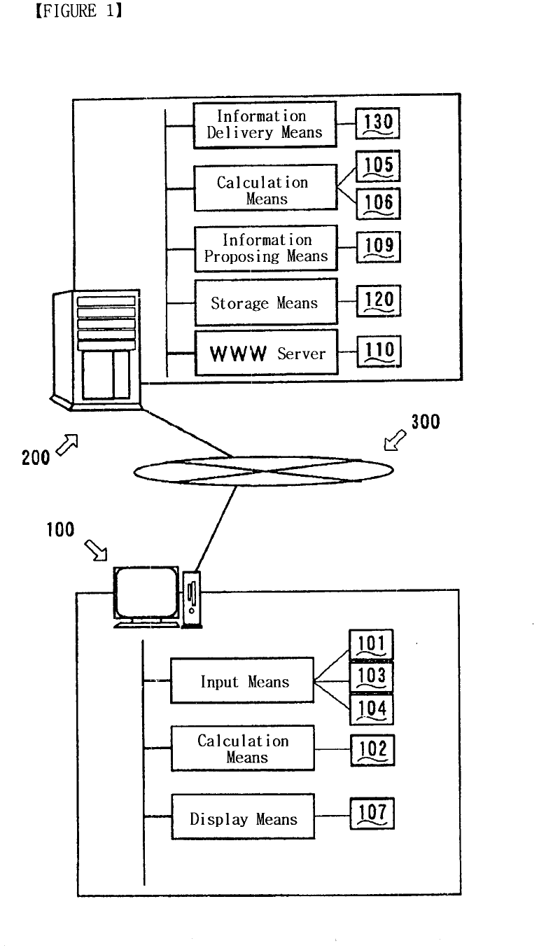

FIG. 1 is a block diagram of a representative ranking system in accordance with the present invention,

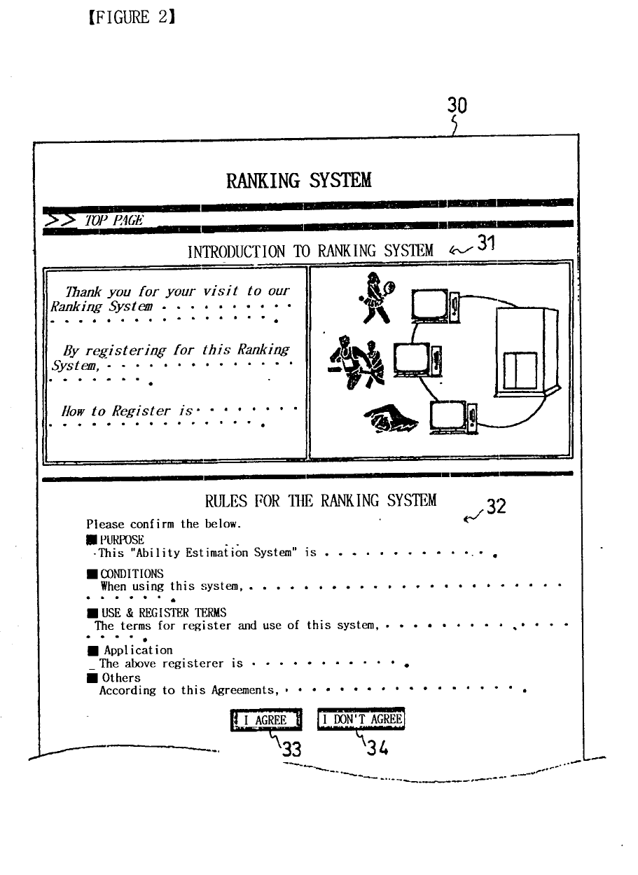

FIG. 2 illustrates Top Page,

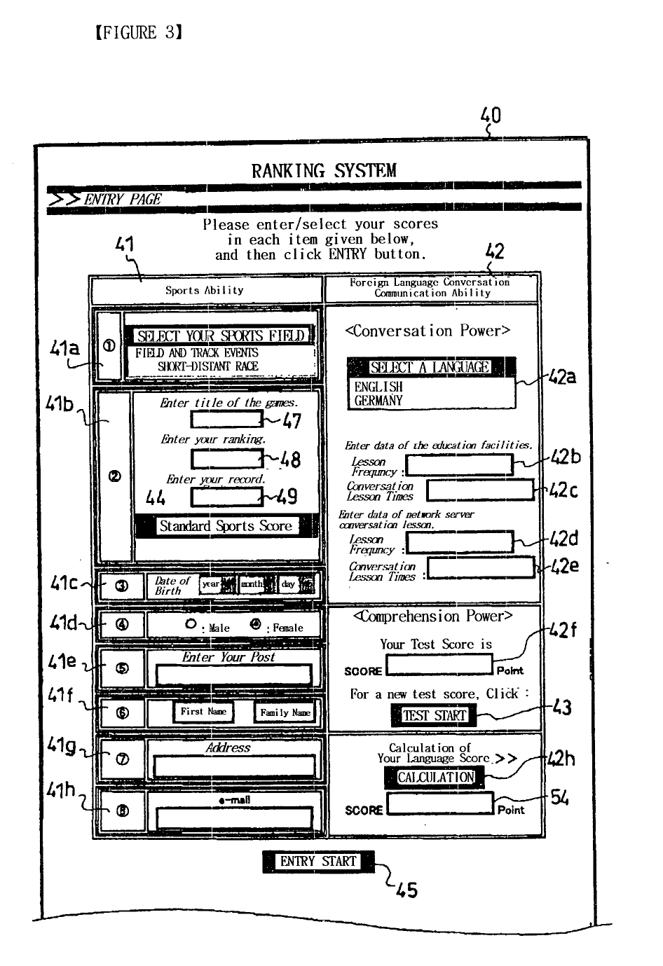

FIG. 3 illustrates Entry Page,

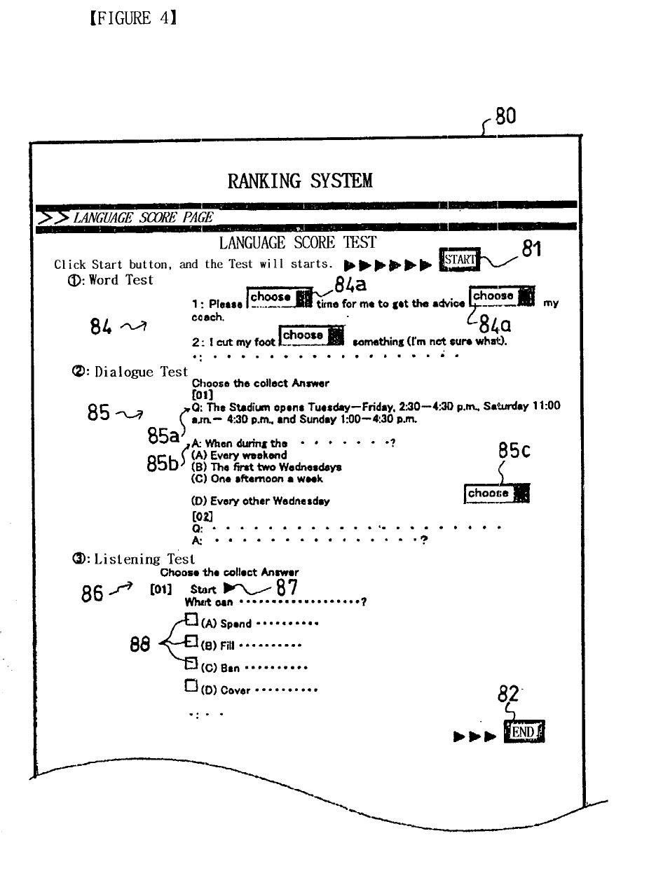

FIG. 4 illustrates Language Score Page,

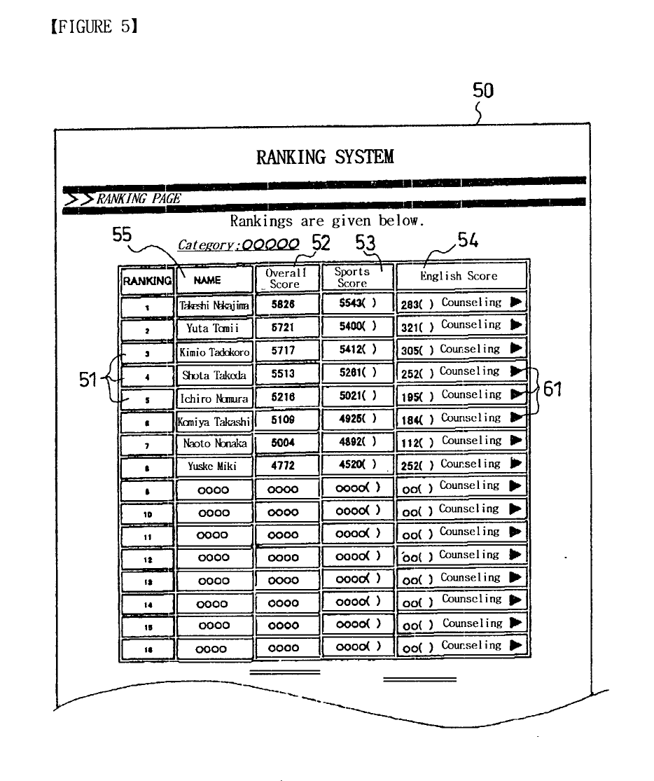

FIG. 5 illustrates Ranking Page,

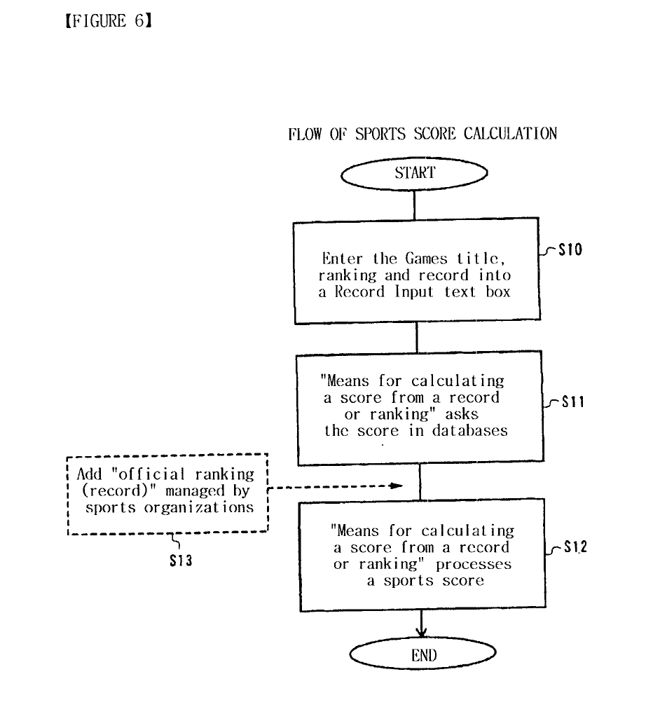

FIG. 6 is a block diagram showing a constitution wherein a network server calculates a ranking,

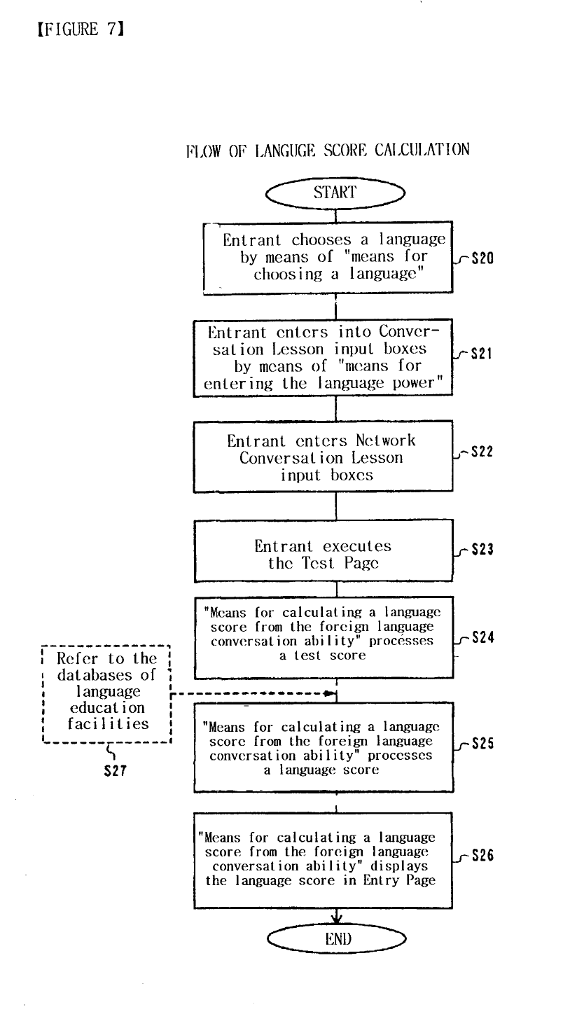

FIG. 7 is a block diagram showing a constitution wherein a network server calculates a sport score,

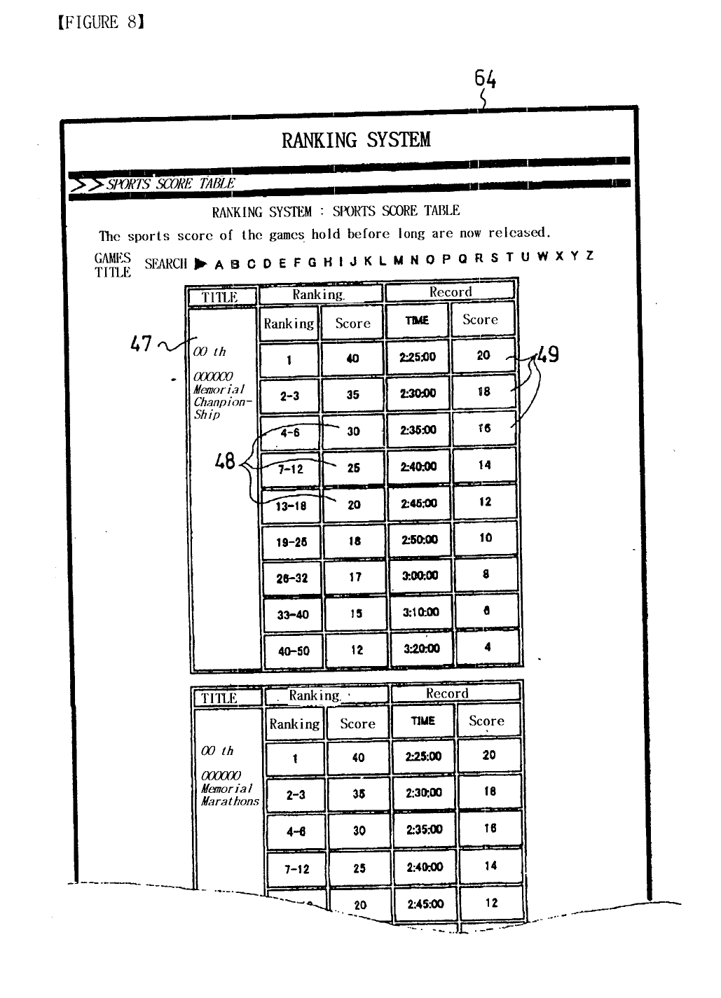

FIG. 8 is a conversion table of sport scores,

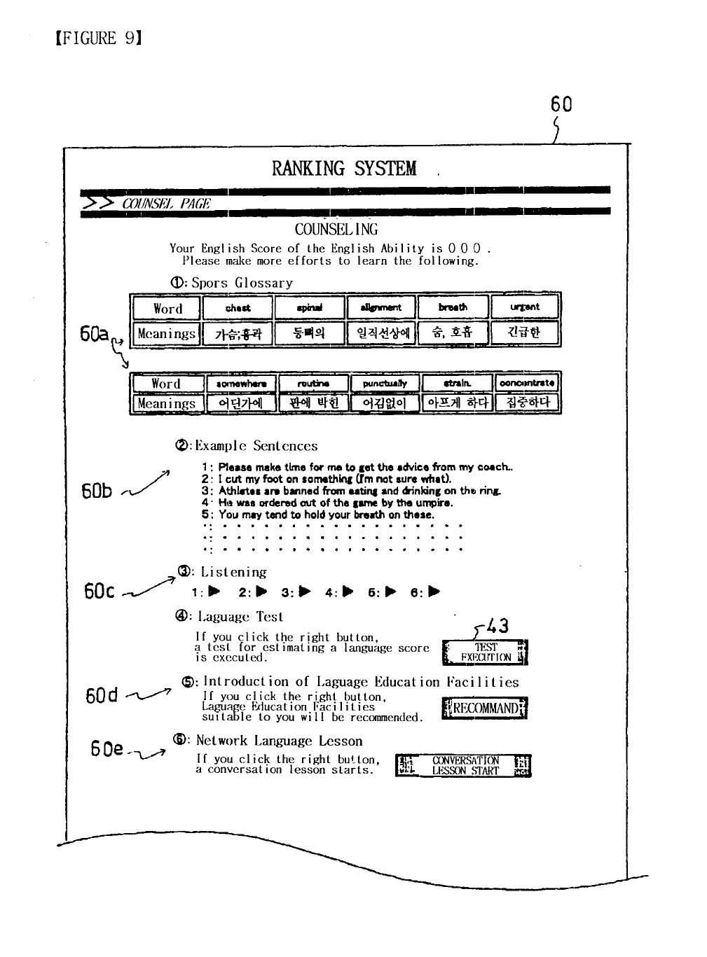

FIG. 9 illustrates Counsel Page,

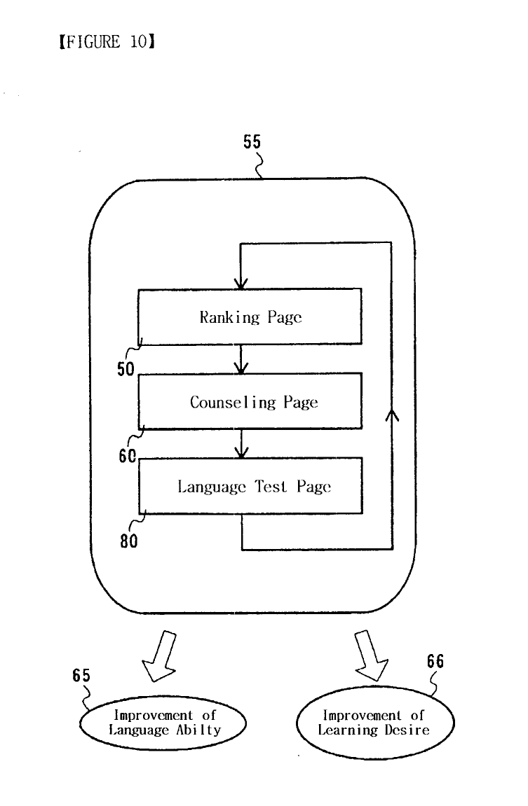

FIG. 10 shows a flow to use Counsel Page and Language Score Page,

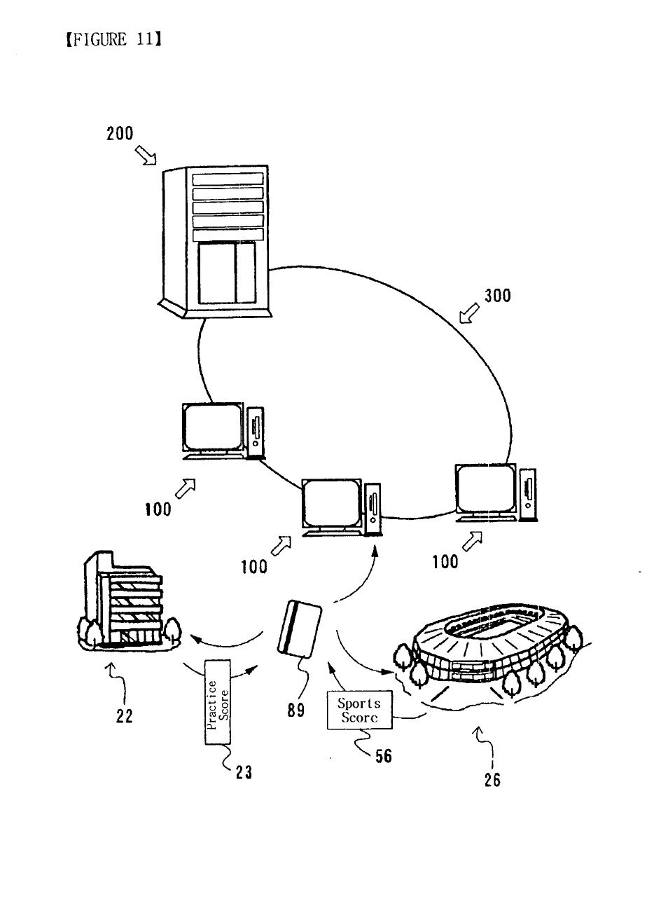

FIG. 11 is a block diagram of a representative embodiment of the international sportsman entry system,

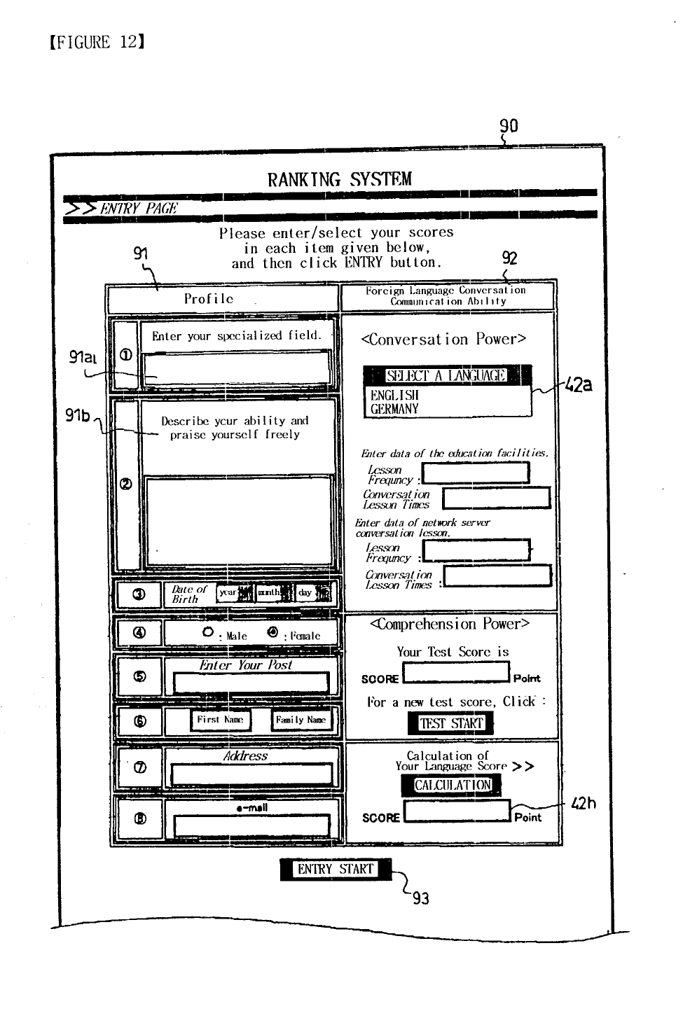

FIG. 12 illustrates Entry Page in the international instructor entry system,

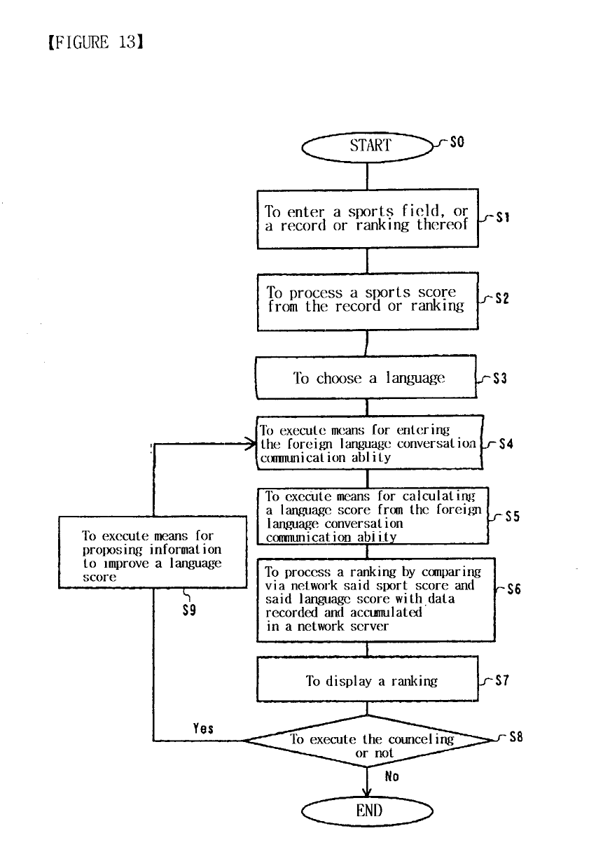

FIG. 13 is a flow chart for processing the ranking system,

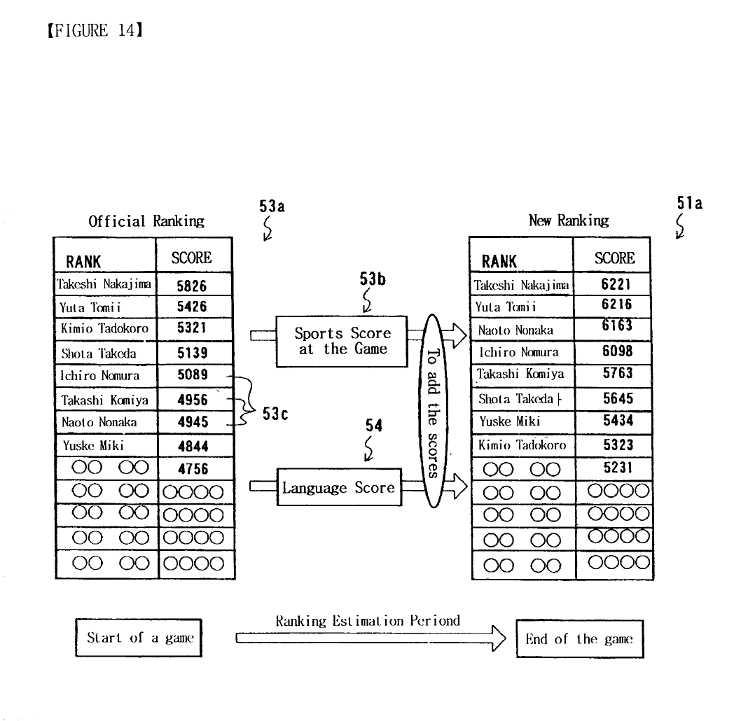

FIG. 14 is a block diagram for producing a new ranking from an official ranking, and

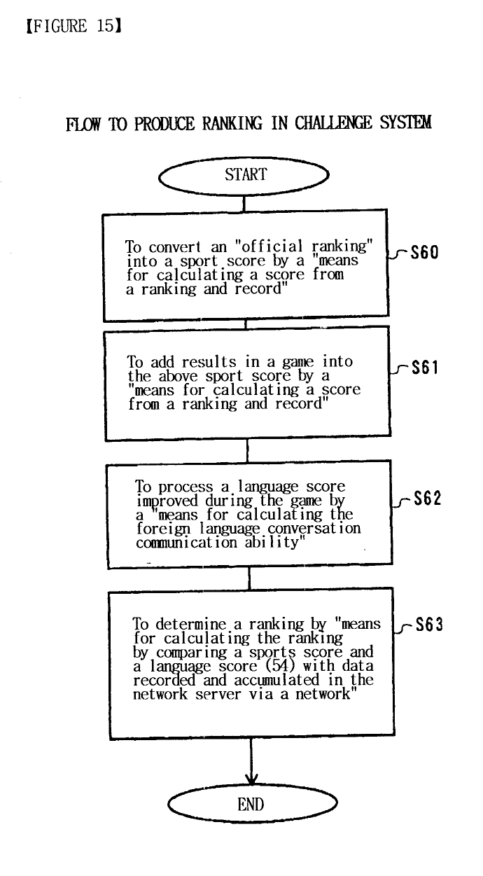

FIG. 15 is also a flow chart.

In the context of the present invention, “click” in each page means that a displayed item is clicked and processed.

From now, the ranking system of the present invention will be illustrated.

As illustrated in FIG. 1, the ranking system comprises “means for entering a sports field or a record or ranking thereof” (101), “means for calculating a sport score from said record or ranking” (102), “means for choosing a language” (103), “means for entering the foreign language conversation communication ability” (104), “means for calculating a language score from said foreign language conversation communication ability” (105), “means for processing a ranking by comparing via network said sport score and said language score with data recorded and accumulated in a network server” (106), and “means for displaying said ranking” (107).

“Means for entering a sports field or a record or ranking thereof” (101) is an input means with which an entrant can input the sports field which the entrant plays, or the entrant's record or ranking in said sports field.

“Means for calculating a sport score from said record or ranking” (102) is a calculation means of a computer (100) or a network server (200), which processes records or rankings of entrants into numerical scores, which are then ranked in order of score.

“Means for choosing a language” (103) is an input means by which an entrant enters the kind of language chosen by the entrant.

“Means for entering the foreign language conversation communication ability” (104) is an input means by which an entrant enters his conversation ability in a foreign language chosen by the entrant.

“Means for calculating a language score from said foreign language conversation communication ability” (105) is a calculation means of the computer (100) or network server (200), which processes the foreign language conversation communication ability into numerical scores, which are then ranked in order of score.

“Means for processing a ranking by comparing via network said sport score and said language score with data recorded and accumulated in a network server” (106) is a calculation means of the computer (100) or network server (200), which prepares a ranking of the sport score and the language score of the entrants.

“Means for displaying the ranking” (107) is a display means by which the computer (100) or the network (200) shows the calculated said ranking prepared as above to entrants or selectors.

In the execution of the above ranking system, a constitution comprising computer (100) which can be operated by a selector and an entrant, a network server (200) and a network (300) linking both of them is employed.

Computer (100) is an audiovisual machine equipped with a display (image machinery) and a sound source tool, which includes, for example, a general-purpose personal computer, PDA (Personal Digital Assistant), a portable telephone, PHS (Personal Handy phone System, etc.

Network server (200) possesses a WWW (World Wide Web) server (110) which transmits data pursuant to the request of the network (300). The WWW (World Wide Web) server (110) is an interface with computer (100) and, if there is a display request from computer (100), transmits various display data which has been stored in a storage means (120) to computer (100), to express the data on the computer (100).

The storage means (120) stores various display data for the web pages in the ranking system, for example, including Top Page (30), Entry Page (40), Ranking page (50), etc. as described below.

Further, in the network server (200), a mail delivery means (130) is installed as an information delivery means and delivers the displayed contents such as the contents of a ranking page (50), a counseling page (60) or the like in an automatic and periodical manner to computers (100) (100 . . . ) of the participants or the entrants.

In the following, a processing flow of the ranking system is explained in detail.

When a top page (30) is requested to be expressed on a computer (100) of a selector or an entrant, in other words, a computer (100) accesses to the top page (30) of web pages established in a network server (200), the top page (30) as shown in FIG. 2 is displayed on the computer (100).

In the context of the present invention, “selector” means a person who employs the results of the ranking system as a measure to estimate the entrant's ability. For example, when the ranking system is employed for the selection of sportsmen as in “international sports entry system” which will be described below, “selector” may mean the selectors of sports organizations.

Further, entrant means a person who registers himself to the ranking system to try to calculate a ranking of his(her) ability or a person who registers his data to the database of the ranking system. For example, when the ranking system is employed for the selection of sportsmen as in “international sports entry system” which will be described below, an entrant may be sportsmen.

In Top Page (30) shown in FIG. 2, there are given a Simple Explanation (31) and a Rules (32), and there are give an “I AGREE” button (33) and an “I DON'T AGREE” button (34).

When clicking the “I AGREE” button (33), an entry page (40) as shown in FIG. 3 is displayed and the operation of the ranking system is started (via SO represented in FIG. 13).

When clicking the “I DON'T AGREE” button (34), a message of “YOU CANNOT USE THE RANKING SYSTEM” is displayed on the screen.

In Entry Page (40) shown in FIG. 3, there are displayed two input frames: a Sports Ability frame (41) which executes “means for entering a sports field or a record or ranking thereof” (101) (via S1 represented in FIG. 13), and a Foreign Language Conversation Communication Ability frame (42) which executes “means for choosing a language” (103) and “means for entering the foreign language conversation communication ability” (104) (via S4 represented in FIG. 13).

In a Sports Ability frame (41), there are given a Sports Kind Selection menu box (41a), a Record Input text box (41b), a Birth Date Input menu box (41c), a Sex Selection radio button (41d), a Post Input text box (41e), a Name Input text box (41f), an Address Input text box (41g), and an Email Address Input text box (41h).

Herein, the above boxes or buttons are illustrated in details as follows.

Sports Kind Selection menu box (41a), is a menu box in which an entrant (a person who are registering for) can choose the sports field that the entrant wishes to register his ranking (hereinafter, referred to as “entry”).

Record Input text box (41b) is a text box in which the sports meeting title (47) that the entrant had participated and results such as ranking (48) and record (49) at the sports meeting are entered. In addition, a Standard Score Table button (44) is given below the Record Input text box (41b), and a Standard Score Table (64) (as in FIG. 8) which will be described below is displayed by clicking the Standard Score Table button (44).

Birth Date Input menu box (41c) is a menu box in which the date of the entrant's birth is entered.

Sex Selection radio button (41c) is a radio button (check button) in which the sex of the entrant is checked.

Post Input text box (41e) is a text box in which a name of the organization or group to which the entrant belongs is entered.

Name Input text box (41f) is a text box in which the entrant's full name is entered.

Address Input text box (41g) is a text box in which the entrant's address is entered.

Email Address Input text box (41h) is a text box in which the entrant's e-mail address is entered.

By inputting or selecting each item given in the Sports Ability frame (41), “means for calculating a sport score from a record or ranking” (102) calculates a sport score (via S2 represented in FIG. 13).

The calculation of a sport score can be represented by a flow chart as shown in FIG. 6. If an entrant enters a sports meeting title (47), a ranking (48) and a record (49) into the Record Input text box (41b) (via S10), “means for calculating a sport score from a record or ranking” (102) will ask database about its point (via S11) to process a sport score (via S12).

Herein, database means a database which is stored in a network server (200) and predetermines points of the ranking (47) and record (49) for each sports meeting title (47), as exemplified in the Standard Score Table (64) shown in FIG. 8.

In addition, the Standard Score Table (64) can be displayed on a screen by clicking a Standard Score Table button (44) (in FIG. 3).

Further, it is possible to manage “official ranking (record)”, which has been managed by sports organizations, as database at a network server (200), and then to add the “official ranking (official record)” to the results entered by an entrant to calculate a sport score at the network server (200) (via S2).

Next, in a Foreign Language Conversation Communication Ability frame (42), there are given a Language Selection menu box (42a), a Conversation Lesson input box (42b)• (42c) for entering the lesson frequency or the conversation lesson time at language education facilities, a Network Conversation input box (42d)• (42e) for entering the lesson frequency or the conversation lesson time provided via a network (300) (for example, lessons which provide a real time conversation with a lecturer), a Test Score (42f), a Test button (43), a Language Score (42g), and a Language Score Calculation button (42h).

In the Language Selection menu box (42a), the most self-confident language of the entrant will be chosen, or a language appointed by a selector is chosen in the “International Sportsmen Entry System” which will described below.

By entering the lesson frequency through the education facilities or computer (100) or the lesson times in a role play or the like into the Conversation Lesson input box (42b)• (42c) or Network Conversation Lesson input box (42d) (42e), “conversation power” of the entrant is reflected to a language score.

Herein, the reason that “lesson frequency lesson time” during which a conversation has happened are employed as criteria for “foreign language conversation communication ability”, in other words, the reason that they are reflected to a language score is based on the fact that a dialogue-type language practice is the most efficient method in order to learn and improve “conversation power” and that the “foreign language conversation communication ability” can be more reasonably estimated by reflecting “lesson frequency/lesson time” to a language score.

As to language education facilities, it includes a language school which is believable and may improve “conversation power” efficiently within a short period, for example by a lesson type wherein a lecturer teaches three students, or a network lesson wherein, for example, a computer of an entrant is online connected via network with a computer of a lecturer in education facilities, and the conversation is performed face to face and in real time by aid of an image device (such as camera, etc.) mounted on terminal machines of both of them and the entrant is comfortable since he is in one's home.

As to the criteria for “lesson frequency• lesson times”, it is possible to employ an estimated level which has been estimated and acknowledged by the language education facilities or in the network conversation lessons.

Herein, the “estimated level” means an acknowledged level wherein a lecturer of the language education facilities or network conversation lessons estimates the degree that a trainee has learned the language and then determines a level on the basis of the estimation criteria such as “freely speaking with the language”, “an extensive vocabulary”, etc.

The test score (42f) (in FIG. 3) is calculated in a test page (70), as exemplified in FIG. 4. TEST PAGE (70) is to estimate only “comprehension power”.

An example of such test page (70) is illustrated below.

At the upper part of TEST PAGE (70), a Start button (81) is given. Test time for a language test is predetermined and given below the Start button (81). For example, where a language test is given 60 minutes of test time, the test time starts right after clicking Start button (81) and then the test will be automatically terminated after a lapse of 60 minutes. Therefore, an entrant (an examinee) should solve within the test time of 60 minute.

In the last part of the TEST PAGE (70), an End button (82) is given. An entrant (an examinee) can arbitrarily terminate the language test by clicking the End button (81).

The test can be divided into three parts: Word Test (84), Dialogue Test (850, and Listening Test (86).

Word Test (84) is a test wherein Word menu boxes (84a)• (84a) are positioned within a short sentence and the most appropriate word in the Word menu boxes (84a)• (84a) should be chosen. Words in the Word menu boxes (84a)• (84a) are listed among the words frequently used in the specific kind of sports that the examinee (entrant) has registered. By means of the Word Test (84), the learning status of words (technical terms) is tested.

Next, Dialogue Test (85) is a test wherein a conversation is supposed and the most appropriate answer (85b) to a question (85a) is chosen from a menu box (85c). By means of this test, comprehension ability is tested.

Next, Listening Test (86) is a test wherein an examinee hears a conversation or report which is regenerated by clicking a Start button (87) which is located next to each question number, chooses the most appropriate answer sentence to the question of the conversation or report, and checks the Check Box (88)• (88). By means of this test, listening ability and comprehension ability are tested.

The test results obtained in Test Page (70) are calculated and processed by the “means for calculating the foreign language conversation communication ability” (104) (via S5 in FIG. 13) and expressed in the Test Score (42f).

In addition, the above test score (42f) can be calculated by assigning merely 1 point for one question in each test (84)• (85) (86), for example, total 100 points for a test having 100 questions, or by assigning different points for each question based on its difficulty. It is also possible to calculate a score of an examinee by a relative estimation of all examinees.

When Language Score Calculation button (42h) (in FIG. 3) is clicked, the calculation of a language score (54) is executed. The flow from input to Output can be represented by a flow chart as shown in FIG. 7. Specifically, an entrant chooses a language by means of a “means for choosing a language” (103) (via S20), the entrant fills the Conversation Lesson input boxes (42b)• (42c) by means of “means for entering the foreign language conversation communication ability” (104) (via S21), the entrant fills the Network Conversation Lesson input boxes (42d)• (42e) (via S22), the entrant executes the Test Page (70) (via S23), the “means for calculating the language score from a foreign language conversation ability” (105) calculates a test score (42f) (via S24), the “means for calculating the language score from a foreign language conversation ability” (105) calculates a language score (54) (via S25), and the “means for calculating the language score from a foreign language conversation ability” (105) display the language score (54) in Entry Page (40) (via S26).

In addition, although the above explanation illustrates that the entrant inputs data with a computer (100), the foreign language conversation ability of an entrant can be managed as databases by language education facilities, and then automatically entered by a network server (200). Therefore, the input or enter operation may be carried out by an entrant as well as a network server, without any specific restriction.

As represented by S27 in FIG. 7, it is possible for the “means for calculating a language score from the foreign language conversation ability” to refer to the databases of language education facilities and then to reflect them to a language score.

When an entrant chooses and/or enters the necessary items in the Entry Page (40) and then clicks the Entry button (45), the calculation of a ranking is started and a Ranking Page as illustrated in FIG. 5 is prepared.

The preparation of said Ranking Page (50) is carried out by “means for processing a ranking by comparing via network said sport score and said language score with data recorded and accumulated in a network server” (106) (via S6 represented in FIG. 13).

The preparation of the Ranking Page (50) can be represented by a flow chart as shown in FIG. 13. As illustrated in FIG. 13, it comprises entering a sports field or its ranking or record (via S1), calculating a score from the record or ranking (via S2), choosing a language (via S3), executing means for entering the foreign language conversation communication ability (via S4), executing means for calculating a language score from the foreign language conversation communication ability (via S5), processing a ranking by comparing via network said sport score and said language score with data recorded and accumulated in a network server (via S6), and displaying the ranking (via S7).

Data recorded and accumulated mean databases which are prepared by recording and accumulating the data that entrants have entered in said entry page (40).

The Ranking Page (50) as shown in FIG. 5 is expressed by an execution of “means for displaying the ranking” (107) and comprises Overall Ranking (51) and three scores such as Overall Score (52), Sport Score (53) and Language Score (53). The Names (55) are sorted in order of the Overall Ranking (51).

When a Name (55) is clicked, the Entry Page as shown in FIG. 3 is displayed and selectors can read the personal information of each entrant.

Further, the displayed contents of the Ranking Page (50) are renewed by each entry of entrants from time to time and the entrants and selectors can get the latest overall ranking (51) in real time.

The displayed contents of Ranking Page (50) are automatically delivered at regular base via email by mail-delivery software (130) (in FIG. 1) to the entrant selector, by which their continuous accesses to the ranking system can be ensured.

According to the above flow, the ranking (51) is calculated and the Ranking Page (50) as exemplified in FIG. 5 is prepared, but the ranking system has a “means for proposing information to improve a language score” (109) in accordance with the results of the language score.

As shown in FIG. 5, a Counseling button (61) is given in the Language Score (54) column of each entrant.

When the Counseling button (61) is clicked (via S8 represented in FIG. 13), the Counseling Page (60) as exemplified in FIG. 9 is displayed (in S9 represented in FIG. 13), in which a “means for proposing information to improve a language score” (109) is executed.

The information provided in the Counseling Page (60) include Sport Glossary (60) of the sports field which an entrant participates, Example Sentence (60b) using an English word listed in the above sport glossary (60a), Listening (60c) in which the example sentences (60b) are read aloud, Introduction of Language Education Facilities (60d), and Network Conversation Lesson (60e).

In Sports Glossary (60a), listed are words frequently used in the sports field of the entrant, especially words which it is required for the entrant to learn in order to improve a language score based on the test result. By learning the words, the entrant can be familiar with words frequently used in the sports field of the entrant.

In Example Sentence (60b), given are example sentence(s) using an English word listed in the above sports glossary (60a). By Example Sentences, the entrant can learn how to use the words listed in sports glossary (60a).

In Listening (60c), the English sentences including word(s) contained in the sports glossary (60a) are read aloud. By repeating the listening (60c), an entrant can learn the pronunciation of each word listed in the sports glossary (60a).

In Introduction of Language Education Facilities (60d), in order to improve the entrant's conversation ability, language education facilities suitable to an entrant and their lectures are introduced in accordance with a language score of the entrant.

In Network Conversation Lesson (60e), a real-time conversation lesson with a lecturer, for example as described above, is provided. By executing the Network Conversation Lesson (60e), the data entered into the Network (Conversation Lesson input box (42d)• (42e) are renewed, the Language Score (54) is renewed, and the Ranking (51) is renewed.

Further, by arranging a Test button (43), the Language Score Page (80) (in FIG. 4) can be executed immediately after learning said Sport Glossary (60a), Example Sentence (60b) and Listening (60c).

Meanwhile, FIG. 4 shows an example of a counseling page (60) in order to improve the “foreign language conversation communication ability” in which the foreign language is English, but is not restricted to “English”. The foreign language is not specifically restricted, but encompass “French”, “German”, “Russian”, “Spanish”, “Chinese”, “Italian”, etc.

The constitution of the ranking system of the present invention is described till now. Examples of using the ranking system are explained below.

First, an example in which the ranking system is used as “International Sportsmen Entry System” is described.

The “International Sportsmen Entry System” means an example, wherein, in order to select “international sportsmen” who are excellent in the sports ability and a foreign language conversation communication ability, an invitation is made from the inside and outside of the country to apply an entry to the “International Sportsmen Entry System” and an overall ranking (51) of the ranking system is used to select “international sportsmen”.

Herein, the term “entry” means an application (or subscription) to an invitation of a selector such as a sports organization or legal entity who plans to select international sportsmen. As to the above invitation which is carried out in every kind of sports, it can include an invitation to the selection of a participating athlete in the Olympics who has a good character as an international sportsman, or an invitation to the selection of an athlete with a good character as an international sportsman who wants to make a sponsorship contract, etc.

From now, the “International Sportsmen Entry System” is illustrated in detail.

An entrant can have a free access to a Network Server (200) from Computer (100) and do an entry by entering necessary information into the Entry Page (40) (in FIG. 3).

Then, the Overall Ranking (51) produced from the entry as described above is delivered via email by a Mail Delivery Software (130) to a selector. The selector uses the Overall Ranking (51) as selection criteria when he selects international sportsmen.

As to said mail delivery, a selector can receive an informational email wherein the information have been adopted or rejected on the basis of the selector's options such as sex, sport field, age, etc.

As described above, a selector can effectively screen “international sportsmen” who are excellent in the sports ability and the foreign language conversation communication ability.

Meanwhile, as to the entrants, they can obtain a “chance of being selected” by their entry.

As described in the foregoing, in the “international sportsmen entry system”, an entrant can have access to a network server (200) via network (300) from a computer (100) in the world, a sport score (53) can be calculated from the “ranking” (48) and/or “record” (49) in games from a locally held small-size game to a worldwide game and combined with a language score (54) to calculate an overall ranking (51), and the entrant can appear in a “stage for selection”.

Thereby, an entrant having an accomplishment in a small-size game can be reasonably estimated as his sport score (53) and obtain a chance of being selected by accumulating his accomplishments.

In addition, since not only a sport score (53) but also a language score (54) are added in the calculation of an overall ranking (51), it is possible for an entrant to pursue the ranking-up of his overall ranking (51) by effectively utilizing said counsel page (80) and language score page (80), and then to increase a chance of being selected.

More specifically, a repetition of the flow in series of Ranking Page (50)→Counsel Page (60)→Language Score Page (80) as illustrated in FIG. 10 can promote “an improvement of the foreign language conversation communication ability” (65) as well as “an improvement of the learning motivation by confirming the language score” (66). And an increase of the motivation for the selection of an entrant will facilitate the training of an international sportsman and the internationalization of the sports, and further increase in an internationalization mind of a people.

As described above, an entrant can recognize his own ability in an objective view and then endeavor after an increase of his “sport ability” and “foreign language conversation communication ability” in order to increase his overall ranking (51); and a selector can effectively carry out a selection of athletes with consideration of the overall ranking (51) which varies in real time.

An effective method of using an “international sportsmen entry system” is not restricted to the method as illustrated above.

For example, a selector can download the personal information such as full name, address and an overall ranking (51) of an entrant in the form of databases from a network server and utilize said information to offer high value added services to the entrant, for example, to offer a preferential opportunity to use sports facilities, lodging facilities, etc., or to offer a preferential opportunity to get language lessons in education facilities, etc.

As illustrated in FIG. 11, a selector can provide an effective method to learn a language by offering an entrant a magnetic card which contains said personal information as a portable hardware (89), having the entrant carry along with the hardware (89), and linking the contents which the entrant learns with said education facilities and at the counsel page (80).

It is possible to add a practice score (23) such as lesson frequency and learning history at the education facilities (22) to the above-mentioned language score (54) (at the Conversation Lesson input box 42b• 42c). As a result, it is possible to reflect the conversation lesson time such as “conversation” or “role play” to the overall ranking (51).

When studying a language, +he conversation lesson time is one important factor to estimate the degree of learning the language. Therefore, the foreign language conversation communication ability can be more reasonably estimated by reflecting the conversation lesson time to an overall ranking (51).

With regard to this point (lesson times), it is also possible for a network server (200) to record and manage in an automatic manner the times of learning (the times of reading, the times of test) at the above mentioned Counsel Page (60) and Language Score Page (80) to reflect the times of learning to an overall ranking (51).

The hardware (89) makes it possible to manage an application for entry at a sports meeting place (26), to record a ranking record as a sport score (56) into the hardware (89), to load up the recorded data from a computer (100) to a network server (200), and/or to update the overall ranking (51).

Next, an example in which the ranking system is used as “International Instructors Entry System” is described.

The “International Instructors Entry System” means an example, wherein, in order to select “international instructors” who have excellent specific ability such as sports ability, technical ability, service mind, etc., as well as foreign language communication ability, entrants are invited from the inside and outside of the country to do an entry to the “International Instructors Entry System” and the overall ranking of the ranking system is used to select the “international instructors”.

Herein, the term “entry” means an application (or subscription) to an invitation of a selector such as a sports organization or legal entity who plans to select “international instructors”. As to the invitation, it can include an invitation to the selection of an instructor who learns technologies from abroad and then transfers them into the country, an invitation to the selection of an instructor who is dispatched for a “cultural exchange” with other countries, an invitation to the selection of an instructor who is dispatched for the transfer and instruction of “industrial technologies”, an invitation to the selection of an instructor who is dispatched abroad by various public welfare organizations, etc.

From now, “International Instructor Entry System” is illustrated in detail.

As to the “International Instructor Entry System”, a Score Input page as shown in FIG. 12 is employed as a format.

In a Profile frame (91), there are given a Field Input text box (91a) in which an entrant freely enters his major sports field, technical field, academic field, or the like, and a Self-Introduction text box (91b) in which an entrant can freely praise himself, etc.

Further, in the Foreign Language Conversation Communication Ability frame (92), there are given a Language Selection menu box (42a), a Language Score Calculating button (42h), or the like.

An entrant can complete his entry by entering the necessary data into the Profile fame (91)• Foreign Language Conversation Communication Ability frame (92) and then clicking the Entry button (93).

The results of such entry are managed as databases in a network server (200) (see FIG. 1) and delivered via e-mail to selectors.

A selector can effectively select a man of talent who is suitable as an international instructor” on the basis of the contents of the email.

The international instructor selected as above can effectively utilize his foreign language conversation communication ability to activate an international cultural exchange and to make a great contribution toward the establishment of multinational friendship relation, the foundation of an international society, etc.

Next, an example in which the ranking system is used as “Challenge System” is described, wherein a new ranking is prepared on the basis of an “official ranking”.

The “Challenge System” comprises holding a sports-meeting, setting the holding period of the meeting as a ranking estimating period, adding the results during the period or an improvement of the foreign language conversation communication ability, and then processing a new ranking. More specifically, as represented in the block diagram of FIG. 14, it comprises disclosing said sport score (53) in “Official Ranking” (53a), converting the results of the game to the game's sport score, which is added to the estimation (score) of said “Official Ranking”, adding an improvement of a language score during the sports meeting, and then processing new ranking (51a).

The preparation of a ranking (51a) in said “Challenge System” can be illustrated in a flow chart as described in FIG. 15.

Specifically, it comprises converting an entrant's “official ranking” into a sport score (53) by means of “means for calculating a score from a ranking and record” (102) (via S20), adding the entrant's result in a game to the above sport score (53) by means of “means for calculating a score from a ranking and record” (102) (via S61), calculating a language score (54) which is improved during the game by means of “means for calculating the foreign language conversation communication ability (104) (via S62), determining the ranking by means of “means for processing a ranking by comparing via network said sport score and said language score with data recorded and accumulated in a network server” (106) (via S63).

In addition, the criteria applied for the preparation of an “official ranking” (53a) (for example, the score (53c) represented in FIG. 14) can be employed for the conversion of an “official ranking” (53a) to a sport score, and it is possible to employ the criteria for “official ranking” (53a) as the conversion standard of sport scores of a game.

By holding such games to which said “Challenge System” is applied, it is possible to increase the sportsman's incentive to the “sport ability” and the “foreign language conversation communication ability”, and it is possible to train good sportsmen who have both of the “sport ability” and the “foreign language conversation communication ability” and will be internationally active.

### EFFECTS OF THE INVENTION

Since the present invention has such constructions as described above, it can achieve the following effects.

As claimed in claim 1, since a ranking system comprises a means for entering a sports field or a record or ranking thereof, a means for calculating a sport score from said record or ranking, a means for choosing a language, a means for entering the foreign language conversation communication ability, a means for calculating a language score from said foreign language conversation communication ability, a means for processing a ranking by comparing via network said sport score and said language score with data recorded and accumulated in a network server, and a means for displaying said ranking, a selector can select a sportsman who is excellent in both of the sports ability and the foreign language conversation communication ability, on the basis of the ranking by using the ranking system.

As claimed in claim 2, since said criteria for estimating the foreign language conversation communication ability comprise the lesson frequency and the conversation lesson time in language education facilities or network conversation lessons, the lesson frequency and the conversation lesson time can be reflected to the language score and “foreign language conversation communication ability” can be more appropriately estimated.

As claimed in claim 3, since said criteria for estimating the foreign language conversation communication ability comprise an estimated level which is acknowledged by language education facilities or during network conversation lessons, the lesson frequency and the conversation lesson time can be reflected to the language score and “foreign language conversation communication ability” can be more appropriately estimated.

As claimed in claim 4, since said ranking system has a means for proposing information to improve a language score as to the resulted language score, an “improvement of the foreign language conversation communication ability of an entrant” as well as “improvement of desire for learning” can be promoted, and an increase of the motivation for the selection of an entrant will facilitate the training of an international sportsman and the internationalization of the sports, and further an increase of the internationalization mind of a people can be promoted.

As claimed in claim 5, since the information offered by said means for proposing information to improve a language score comprises a list of the words used in the sports field in which an entrant participates, an example sentence using the word(s) and a voice information reading aloud the above example sentence, the entrant can be familiar with words frequently used in the sports field of the entrant, learn how to use the words listed in sports glossary (60a) by means of example sentences, and learn the pronunciation by means of the voice information.

As claimed in claim 6, since the information offered by said means for proposing information to improve a language score comprises an introduction of language education facilities and network conversation lessons, the entrant can easily obtain information to improve “conversation power” and can try to improve his “conversation power”.

As claimed in claim 7, since the contents of said ranking are automatically delivered to the computers of a selector and an entrant by means of an information delivery means installed in a network server, the entrant can endeavor after level-up of his “sports ability” and “foreign language conversation communication ability” in order to increase his overall ranking; and a selector can effectively carry out a selection of athletes with consideration of the overall ranking which varies in real time.

As claimed in claim 8, since the result of said ranking is employed as the criteria for selecting international sportsmen who are excellent in the sports ability and the foreign language conversation communication ability, a selector can effectively screen “international sportsmen” who are excellent in the sports ability and the foreign language conversation communication ability.

Meanwhile, as to the entrants, they can obtain a “chance of being selected” by their entry. That is, an entrant can have access to a network server via network from a computer in the world, a sport score can be calculated from the “ranking” and/or “record” in games from a locally held small-size game to a worldwide game and combined with a language score to calculate an overall ranking, and therefore, the entrant can appear in a “stage for selection”.

In addition, an entrant can endeavor after the ranking-up of his overall ranking by effectively utilizing said counsel page and language score page, and then to increase a chance of being selected.

As claimed in claim 9, since the result of said ranking is employed as the criteria for selecting international instructors who are excellent in a special technology or skill and the foreign language conversation communication ability, a selector can effectively select a man of talent who is suitable as an international instructor” on the basis of the contents of the ranking.

The “international instructor” selected as above can efficiently utilize his foreign language conversation communication ability to activate an international cultural exchange and to make a great contribution toward the establishment of multinational friendship relation, the foundation of an international society, etc.

As claimed in claim 10, said ranking is prepared by adding the above sport score and language score to the existing official ranking, a new ranking is prepared from the resulted ranking, and the new ranking is employed as the criteria for selecting a sportsman who has both of the sports ability and the foreign language conversation communication ability. Therefore, by holding such games to produce new ranking, it is possible to increase the sportsman's incentive to the “sport ability” and the “foreign language conversation communication ability”, and it is possible to develop or train good sportsmen who have both of the “sport ability” and the “foreign language conversation communication ability” and will be internationally active.

As claimed in claim 11, since a method of ranking sportsmen or instructors comprises a step for entering a sports field or a record or ranking thereof, a step for calculating a sport score from said record or ranking, a step for choosing a language, a step for entering the foreign language conversation communication ability, a step for calculating a language score from said foreign language conversation communication ability, a step for processing a ranking by comparing via network said sport score and said language score with data recorded and accumulated in a network server, and a step for displaying said ranking, a selector can select a sportsman who is excellent in both of the sports ability and the foreign language conversation communication ability, on the basis of the ranking by using the ranking system.

While the invention has been described by reference to specific embodiments chosen for purposes of illustration, it should be apparent that numerous modifications could be made thereto by those skilled in the art without departing from the basic concept and scope of the invention.

1. A ranking system comprising:
a means for entering a sports field or a record or ranking thereof, a means for calculating a sport score from said record or ranking, a means for choosing a language, a means for entering the foreign language conversation communication ability, a means for calculating a language score from said foreign language conversation communication ability, a means for processing a ranking by comparing via network said sport score and said language score with data recorded and accumulated in a network server, and a means for displaying said ranking.

2. The ranking system according to claim 1, wherein criteria for estimating the foreign language conversation communication ability comprise the lesson frequency and the conversation lesson time in language education facilities or network conversation lessons.

3. The ranking system according to claim 1 or 2, wherein the criteria for estimating the foreign language conversation communication ability comprise an estimated level which is acknowledged by language education facilities or during network conversation lessons.

4. The ranking system according to any one of claims 1 to 3, wherein, as to the resulted language score, said ranking system has a means for proposing information to improve a language score.

5. The ranking system according to any one of claims 1 to 4, wherein the information offered by the above means for proposing information to improve a language score comprises a list of the words used in the sports field in which the entrant participates, an example sentence using the word(s), and a voice information reading aloud the above example sentence.

6. The ranking system according to any one of claims 1 to 5, wherein the information offered by the above means for proposing information to improve a language score comprises an introduction of language education facilities and network conversation lessons.

7. The ranking system according to any one of claims 1 to 6, wherein the contents of the resulted ranking are automatically delivered to the computers of a selector and an entrant by means of an information delivery means installed in a network server.

8. The ranking system according to any one of claims 1 to 7, wherein the resulted ranking is employed as the criteria for selecting international sportsmen who are excellent in the sports ability and the foreign language conversation communication ability.

9. The ranking system according to any one of claims 1 to 7, wherein the resulted ranking is employed as the criteria for selecting international instructors who are excellent in a special technology or skill and the foreign language conversation communication ability.

10. The ranking system according to any one of claims 1 to 9, wherein said ranking is prepared by adding the above sport score and language score to the existing official ranking, a new ranking is prepared from the resulted ranking, and the new ranking is employed as the criteria for selecting a sportsman who has both of the sports ability and the foreign language conversation communication ability.

11. A method of ranking sportsmen or instructors, which comprises:
a step for entering a sports field or a record or ranking thereof, a step for calculating a sport score from said record or ranking, a step for choosing a language, a step for entering the foreign language conversation communication ability, a -step for calculating a language score from said foreign language conversation communication ability, a step for processing a ranking by comparing via network said sport score and said language score with data recorded and accumulated in a network server, and a step for displaying said ranking.
